(19) United States
(12) Patent Application Publication
(10) Pub. No.: US 2013/0063860 A1
(43) Pub. Date: Mar. 14, 2013

(54) LEAD UNIT OF ENERGY STORAGE DEVICE

(71) Applicants: Young Hak JEONG, Gyeonggi-do (KR); Chan YOON, Seoul (KR); Hyun Chul JUNG, Gyeonggi-do (KR); Bae Kyun KIM, Gyeonggi-do (KR)

(72) Inventors: Young Hak JEONG, Gyeonggi-do (KR); Chan YOON, Seoul (KR); Hyun Chul JUNG, Gyeonggi-do (KR); Bae Kyun KIM, Gyeonggi-do (KR)

(73) Assignee: SAMSUNG LECTRO-MACHANICS CO., LTD.

(21) Appl. No.: 13/570,828

(22) Filed: Aug. 9, 2012

(30) Foreign Application Priority Data
Sep. 9, 2011 (KR) 10-2011-0091836

(51) Int. Cl. H01G 4/012

(52) U.S. Cl. 361/304

(57) ABSTRACT

Disclosed herein is a lead unit of an energy storage device including a lead frame for fixing withdrawal electrodes of the energy storage device, including: an output terminal unit formed on an upper portion of the lead frame; a lead unit formed to extend from the output terminal unit to a lower portion of the lead frame and allowing end portions of the withdrawal electrodes to be inserted therein; and an expanding unit formed at an end portion of the lead unit and being brought into contact with the withdrawal electrodes in a compressed manner.

The fabrication process can be simplified compared with the existing welding method, and a contact area between the withdrawal electrodes and the lead unit can be increased to thus reduce contact resistance.

### CROSS REFERENCE(S) TO RELATED APPLICATIONS

This application claims the benefit under 35 U.S.C. Section 119 of Korean Patent Application Serial No. 10-2011-0091836, entitled “Lead Unit of Energy Storage Device” filed on Sep. 9, 2011, which is hereby incorporated by reference in its entirety into this application.

### BACKGROUND OF THE INVENTION

1. Technical Field

The present invention relates to an energy storage device and, more particularly, to a lead unit of an energy storage device capable of simply and effectively performing a process of electrically connecting a withdrawal lead of an energy storage device and a lead unit and reducing contact resistance by increasing an electrical contact area between the withdrawal lead and the lead unit, in comparison to an existing welding method.

2. Description of the Related Art

An electric dual-layer capacitor such as a super capacitor is an energy storage device using a pair of electrode layers having different polarities, which can be rapidly charged and discharged, is resistant to over-charging or over-discharging, has a long life span because it does not involve a chemical reaction, can be used in a wide temperature range, and does not contain heavy metal to thus prevent environmental pollution, and the like.

The structure of the electric dual-layer capacitor such as a super capacitor according to the related art will be described as follows.

With reference to FIGS. 1 and 2, the related art super capacitor includes a current collector 10 in which a plurality of negative electrode plates and a plurality of positive electrode plates are alternately laminated, and an external case 20 in which the current collector 10 is received or accommodated.

Here, an end portion of the current collector 10 includes a negative withdrawal electrode 11 drawn out of the plurality of negative electrode plates and a positive withdrawal electrode 12 drawn out of the plurality of positive electrode plates.

The negative withdrawal electrode 11 and the positive withdrawal electrode 12 are riveted to a lead frame 21 provided on the external case 20 by a plurality of rivets 22 so as to be electrically connected with the rivets 22, and accordingly, outer end portions 22a of the rivets 22 form an output terminal portion for an external electrical connection.

In detail, holes 11a and 12a are formed on the negative withdrawal electrode 11 and the positive withdrawal electrode 12 of the current collector 10, through which the leads 22b of the rivets 22 penetrate.

The leads 22b of the rivets 22 are inserted to the holes 11a and 12a of the negative withdrawal electrode 11 and the positive withdrawal electrode 12 through the lead frame 21, from an upper portion to a lower portion of the lead frame 21, and protruded end portions of the leads 22b are riveted. Namely, the leads 22b of the rivets 22 are in contact with the negative withdrawal electrode 11 and the positive withdrawal electrode 12 in a compressed manner.

Thus, the negative withdrawal electrode 11 and the positive withdrawal electrode 12 are electrically connected with the respective rivets 22, and accordingly, the rivets 22 may form an input/output external terminal for electrically connecting the energy storage device to the outside.

Here, the end portions of the leads 22b of the rivets 22 are riveted with washers 23 provided thereto, bonding strength between the withdrawal electrodes 11 and 12 and the leads 22b of the rivets 22 can be strengthened.

However, the leads 22b of the related art rivets 22 are formed to have a shape of a linear bar with a much smaller diameter so as to penetrate the lead frame 21 and the holes 11a and 12a formed on the negative withdrawal electrode 11 and the positive withdrawal electrode 12.

Thus, when the leads 22b of the rivets 22 are riveted so as to be compressed in contact with the negative withdrawal electrode 11 and the positive withdrawal electrode 12, the area of the leads 22b of the rivets 22 in contact with the negative withdrawal electrode 11 and the positive withdrawal electrode 12 is small, increasing contact resistance to degrade power input/output characteristics and charging and discharging efficiency.

Also, since the leads 22b of the rivets 22 are formed to have the shape of a linear bar with a small diameter, if riveting is not accurately performed, end portions of the leads 22b cannot be smoothly compressed to the negative withdrawal electrode 11 and the positive withdrawal electrode 12, further reducing the contact area, which increases the contact resistance.

Thus, in order to resolve the problem, the leads 22b of the rivets 22 and the negative withdrawal electrode 11 and the positive withdrawal electrode 12 are bonded by welding such as ultrasonic joining, or the like, but this method involves complicated processes and incurs high processing costs in comparison to the compression method through riveting.

### SUMMARY OF THE INVENTION

An object of the present invention is to provide a lead unit of an energy storage device capable of improving performance such as charging and discharging efficiency by increasing a contact area between a withdrawal electrode and the lead unit to thus reduce contact resistance with respect to electrical connection.

Another object of the present invention is to provide a lead unit of an energy storage device capable of simplifying processes and reducing the cost required for a process to make a withdrawal electrode and a lead unit come into contact, in comparison to an existing welding method.

According to an exemplary embodiment of the present invention, there is provided a lead unit of an energy storage device including a lead frame for fixing withdrawal electrodes of the energy storage device, including: an output terminal unit formed on an upper portion of the lead frame; a lead unit formed to extend from the output terminal unit to a lower portion of the lead frame and allowing end portions of the withdrawal electrodes to be inserted therein; and an expanding unit formed at an end portion of the lead unit and being brought into contact with the withdrawal electrodes in a compressive manner.

The output terminal unit, the lead unit, and the expanding unit may be integrally formed with the lead frame.

The output terminal unit, the lead unit, and the expanding unit may be formed with the lead frame through a dual-injection molding method.

The lead frame may be made of an insulating material and the output terminal unit, the lead unit, and the expanding unit may be made of a material having electric conductivity.

The expanding unit may be made of an aluminum material.

The expanding unit may have a disk-like shape.

The expanding unit may have a conical shape.

An upper end portion of the expanding unit may be formed to be tightly attached to a lower surface of the lead frame so as to minimize the lead unit.

The expanding unit may be formed to have a diameter that gradually increases and then gradually reduces downwardly.

An insertion recess may be formed on an end portion of the withdrawal electrodes and inserted into the lead unit.

The expanding unit may be compressed by a riveting machine so as to be brought into contact with the withdrawal electrodes.

### BRIEF DESCRIPTION OF THE DRAWINGS

FIG. 1 is a perspective view showing an example of an energy storage device according to the related art.

FIG. 2 is an exploded perspective view schematically showing a lead unit of the energy storage device according to the related art.

FIG. 3 is a schematic perspective view of a lead unit of an energy storage device according to a first embodiment of the present invention.

FIG. 4 is a schematic perspective view of a lead unit of an energy storage device according to a second embodiment of the present invention.

FIG. 5 is a schematic perspective view of a lead unit of an energy storage device according to a third embodiment of the present invention.

FIG. 6 is a schematic perspective view of a lead unit of an energy storage device according to a fourth embodiment of the present invention.

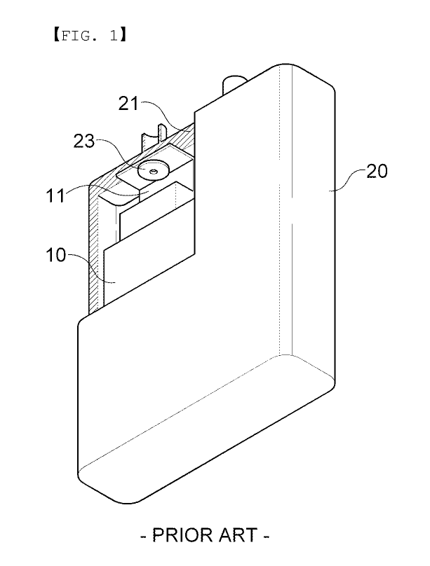

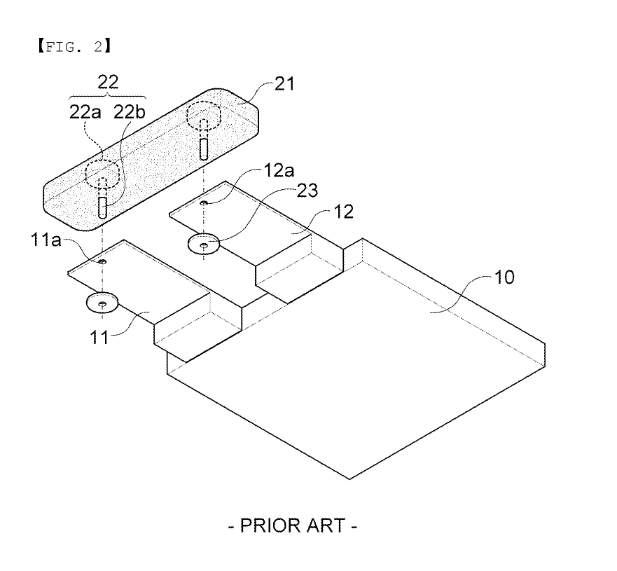

### DESCRIPTION OF THE PREFERRED EMBODIMENTS

Exemplary embodiments of the present invention in which objects of the present invention may be specifically implemented will be described with reference to the accompanying drawings. In exemplary embodiments of the present invention, the same terms and reference numerals will be used to describe the same components. Therefore, an additional description for the same component will be omitted below.

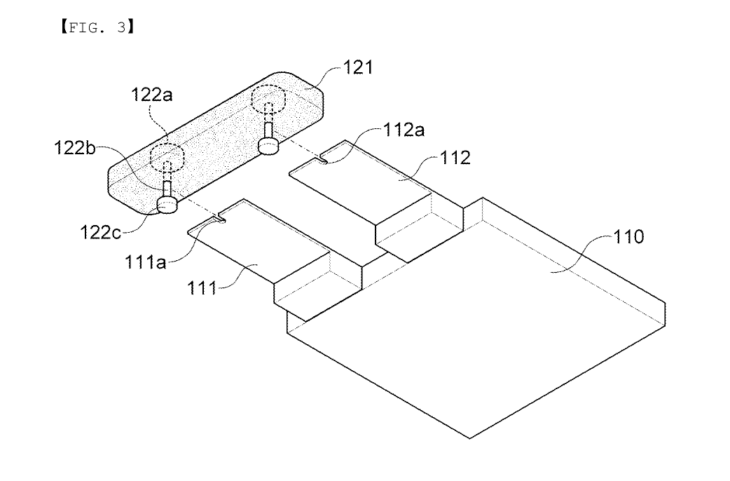

Hereinafter, a lead unit of an energy storage device according to embodiments of the present invention will be described in detail with reference to FIGS. 3 through 6.

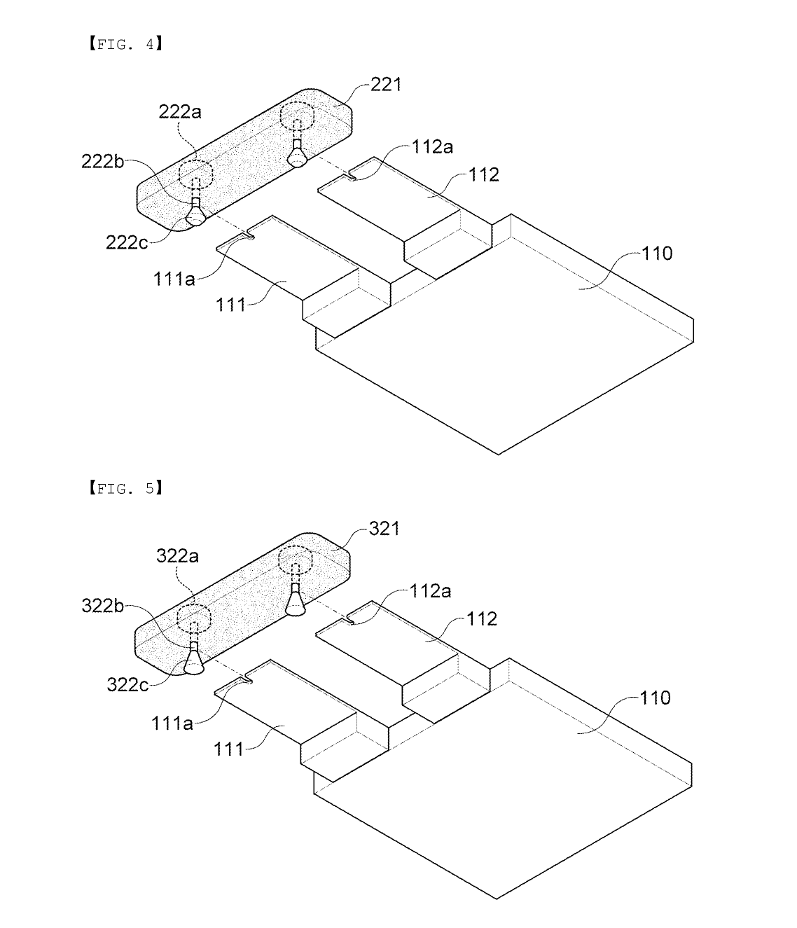

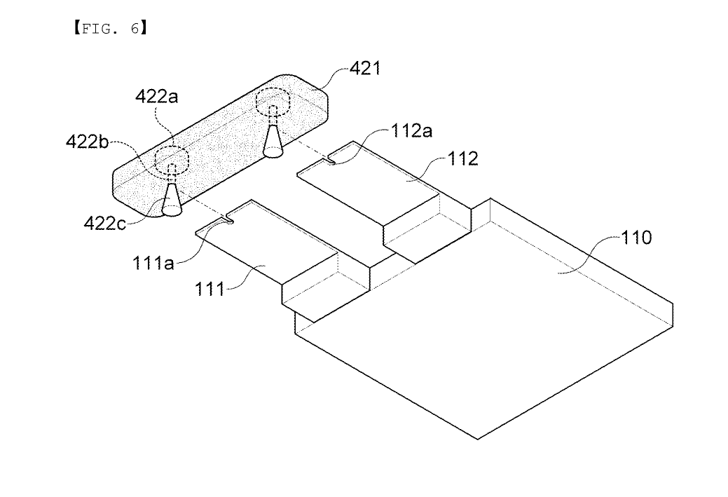

FIG. 3 is a schematic perspective view of a lead unit of an energy storage device according to a first embodiment of the present invention, FIG. 4 is a schematic perspective view of a lead unit of an energy storage device according to a second embodiment of the present invention, FIG. 5 is a schematic perspective view of a lead unit of an energy storage device according to a third embodiment of the present invention, and FIG. 6 is a schematic perspective view of a lead unit of an energy storage device according to a fourth embodiment of the present invention.

First, with reference to FIG. 3, a lead unit according to a first embodiment of the present invention may include a lead frame 121 to which a negative withdrawal electrode 111 and a positive withdrawal electrode 112 drawn out of a current collector 110 of the energy storage device, i.e., a super capacitor, are fixed.

A lead unit of the energy storage device according to the present embodiment may include an output terminal unit 122a formed on an upper portion of the lead frame 121, a lead unit 122b formed to extend from the output terminal unit 122a to a lower portion of the lead frame 121 and allowing an end portion of the negative withdrawal electrode 111 or the positive withdrawal electrode 112 to be inserted therein, and an expanding unit 122c formed at an end portion of the lead unit 112b and being brought into contact with the negative withdrawal electrode 111 or the positive withdrawal electrode 112 in a compressive manner.

Here, the output terminal unit 122a, the lead unit 122b, and the expanding unit 112c may be integrally formed with the lead frame 121.

To this end, the output terminal unit 122a, the lead unit 122b, and the expanding unit 122c may be integrally formed with the lead frame 121 through a dual-injection molding method.

Here, the lead frame 121 may be made of an insulating material, and the output terminal unit 122a, the lead unit 122b, and the expanding unit 122c may be made of a material having electric conductivity for an external electrical connection of the negative withdrawal electrode 111 or the positive withdrawal electrode 112.

Here, the expanding unit 112c may have electric conductivity and made of an aluminum material so as to be easily compressed to the negative withdrawal electrode 111 or the positive withdrawal electrode 112 when riveted, but the present invention is not limited thereto.

In the lead unit of the energy storage device according to the present embodiment, the expanding unit 122c may have a disk-like shape.

Meanwhile, insertion recesses 111a and 112a may be formed on end portions of the negative withdrawal electrode 111 and the positive withdrawal electrode 112, respectively, and inserted into the lead unit 122b.

A process for assembling the lead unit of the energy storage device according to the present embodiment configured as described above will be described as follows.

First, the negative withdrawal electrode 111 and the positive withdrawal electrode 112 of the current collector 110 are inserted through the respective insertion recesses 111a and 112a to the lead units 112b protruded from the lower portion of the lead frame 121.

The expanding unit 122c may be riveted so as to be fixedly compressed to the negative withdrawal electrode 111 and the positive withdrawal electrode 112 by using a riveting machine.

Here, although not shown in detail, in order to enhance contact strength and bonding strength between the expanding units 122c and the negative withdrawal electrode 111 and the positive withdrawal electrode 112, the expanding units 122c may be riveted in a state in which a washer (not shown) made of a metal material having electric conductivity is interposed between the expanding units 122c and the lead units 122b.

According to the present embodiment, since the lead units 122b include the expanding units 122c and the expanding units 122c are riveted so as to be compressed to the negative withdrawal electrode 111 and the positive withdrawal electrode 112, whereby the contact area between the withdrawal electrodes 111 and 112 of the current collector 110 and the lead unit can be increased. Accordingly, contact resistance between the electrical connection members can be reduced and the performance such as charging and discharging efficiency, or the like, of the energy storage device can be enhanced.

Also, according to the present embodiment, since the lead unit for an external connection of the energy storage device is configured to include the output terminal unit 122a, the lead unit 122b, and the expanding unit 122c integrally formed with the lead frame 121 and used for an external connection of the energy storage device, the related art processes of inserting the leads of the rivets into the lead frame and then inserting the leads to the insertion holes formed on the respective withdrawal electrodes, or the like, can be omitted, and thus, the process can be simplified and costs required for the fabrication process can be reduced.

Also, according to the present embodiment, since the expanding unit 122c having an increased size from the lead unit 122b is riveted and come into electrical contact with the withdrawal electrodes 111 and 112, the riveting fixation can be accurately, stably, and easily performed in comparison to the related art riveting of only the thin and extended lead units.

FIG. 4 is a schematic perspective view of a lead unit of an energy storage device according to a second embodiment of the present invention. Compared with the foregoing first embodiment, the structure of an expanding unit 222c is modified.

Namely, a lead unit of an energy storage device according to the second embodiment of the present invention may include an output terminal unit 222a formed on an upper portion of a lead frame 221, a lead unit 222b formed to extend from the output terminal unit 222a to a lower portion of the lead frame 221 and allowing an end portion of the negative withdrawal electrode 111 or the positive withdrawal electrode 112 to be inserted therein, and an expanding unit 222c formed at an end portion of the lead unit 222b and being brought into contact with the negative withdrawal electrode 111 or the positive withdrawal electrode 112 in a compressed manner, and here, the expanding unit 222c is formed to have a diameter that gradually increases and then gradually reduces downwardly.

The configuration and operation of the lead unit of the energy storage device according to the present embodiment are the same as those of the first embodiment, except for the shape of the expanding unit 222c, so a detailed description thereof will be omitted.

FIG. 5 is a schematic perspective view of a lead unit of an energy storage device according to a third embodiment of the present invention. Compared with the foregoing first embodiment, the structure of an expanding unit 322c is modified.

Namely, a lead unit of an energy storage device according to the third embodiment of the present invention may include an output terminal unit 322a formed on an upper portion of a lead frame 321, a lead unit 322b formed to extend from the output terminal unit 322a to a lower portion of the lead frame 321 and allowing an end portion of the negative withdrawal electrode 111 or the positive withdrawal electrode 112 to be inserted therein, and an expanding unit 322c formed at an end portion of the lead unit 322b and being brought into contact with the negative withdrawal electrode 111 or the positive withdrawal electrode 112 in a compressive manner, and here, the expanding unit 322c is formed to have a conical shape having a diameter increased downwardly.

The configuration and operation of the lead unit of the energy storage device according to the present embodiment are the same as those of the first embodiment, except for the shape of the expanding unit 322c, so a detailed description thereof will be omitted.

FIG. 6 is a schematic perspective view of a lead unit of an energy storage device according to a fourth embodiment of the present invention. Compared with the foregoing third embodiment, an upper end portion of an expanding unit 422c is formed to be tightly attached to a lower surface of a lead frame 421.

Thus, according to the fourth embodiment of the present invention, the length of the lead unit can be minimized, and riveting can be performed in a state in which the withdrawal electrodes 111 and 112 are more press-fit to the expanding units 422c.

The configuration and operation of the lead unit of the energy storage device according to the present embodiment are the same as those of the third embodiment, except for the lead unit, so a detailed description thereof will be omitted.

According to the exemplary embodiments of the present invention, in the lead unit of the energy storage device, since the contact area between the withdrawal electrodes of the energy storage device and the lead unit is increased, reducing contact resistance with respect to electrical connection, the performance such as charging and discharging efficiency of the energy storage device, or the like, can be enhanced.

Also, according to the exemplary embodiments of the present invention, in the lead unit of the energy storage device, the processes can be simplified compared with the existing welding method, and the costs required for the process of making the withdrawal electrodes and the lead unit come into contact can be reduced.

In addition, according to the exemplary embodiments of the present invention, in the lead unit of the energy storage device, since the expanding unit is formed on the end portion of the lead unit, riveting can be more accurately and easily performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A lead unit of an energy storage device including a lead frame for fixing withdrawal electrodes of the energy storage device, the lead unit comprising:
an output terminal unit formed on an upper portion of the lead frame;
a lead unit formed to extend from the output terminal unit to a lower portion of the lead frame and allowing end portions of the withdrawal electrodes to be inserted therein; and
an expanding unit formed at an end portion of the lead unit and being brought into contact with the withdrawal electrodes in a compressed manner.

2. The lead unit according to claim 1, wherein the output terminal unit, the lead unit, and the expanding unit are integrally formed with the lead frame.

3. The lead unit according to claim 2, wherein the output terminal unit, the lead unit, and the expanding unit are formed through a dual-injection molding method.

4. The lead unit according to claim 1, wherein the lead frame is made of an insulating material and the output terminal unit, the lead unit, and the expanding unit are made of a material having electric conductivity.

5. The lead unit according to claim 4, wherein the expanding unit is made of an aluminum material.

6. The lead unit according to claim 1, wherein the expanding unit has a disk-like shape.

7. The lead unit according to claim 1, wherein the expanding unit has a conical shape.

8. The lead unit according to claim 7, wherein an upper end portion of the expanding unit is formed to be tightly attached to a lower surface of the lead frame.

9. The lead unit according to claim 1, wherein the expanding unit is formed to have a diameter that gradually increases and then gradually reduces downwardly.

10. The lead unit according to claim 1, wherein an insertion recess is formed on an end portion of the withdrawal electrodes and inserted into the lead unit.

11. The lead unit according to claim 1, wherein the expanding unit is compressed by a riveting machine so as to be brought into contact with the withdrawal electrodes.
